(19) United States
(12) Patent Application Publication
(10) Pub. No.: US 2007/0014922 A1
(43) Pub. Date: Jan. 18, 2007

(54) Method of processing porous building materials

(75) Inventors: Leonid Matrossov, Vladimir (RU); Vladimir Barankov, Malygino (RU)

Correspondence Address: Ka Man Mark Tong;Suite 100, 2050 North Plano Road, Richardson, TX, 75082, US

(73) Assignee: Novaatorid Grupp OU (an Estonian corporation), Tallinn (EE)

(21) Appl. No.: 11/182,426

(22) Filed: Jul. 15, 2005

(51) Int. Cl. B05D 3/00; B05D 7/00

(52) U.S. Cl. 427/294; 427/421.1

(57) ABSTRACT

A method of processing porous building materials in an impregnation chamber is disclosed. The are placed into the chamber and subjected to a vacuum for about 10 minutes. Then a mixture of a dye with a hydrophobic impregnant (liquid) is sprayed into the chamber at the pressure of 6 to 30 atm, thereby creating gas-like misty environment. The material is subjected to the misty environment for 0.5 to 10 minutes while gradually increasing the pressure in the chamber until the atmospheric pressure. Latex or acrylic based dyes with diffusion qualities and silicone based hydrophobic liquids possessing film qualities are used. Materials processed include bricks, cement and qypsum-based materials, natural stone, wood and timber based products, and ceramics.

### BACKGROUND

1. Technical Field

The invention relates to the field of building materials, namely to methods of processing porous building materials so that they can be used in adverse weather conditions, and to methods of providing such materials with finished look in a variety of colors.

2. Background of the Invention

SU authors certificate No 1463731 describes a “Method of impregnating porous materials”, comprising impregnating the material in a chamber, lower part of which is filled with an impregnating liquid. First the material is treated in a vacuum at 0.3 atm. Then the steamed and dried material is placed into liquid impregnating bitumen heated up to 160° C., and is exposed to it in vacuum for 1 hour. Then the pressure is taken up to the atmospheric pressure momentarily. Pressure and vacuum are alternately applied until the required depth of impregnation of the material (1.45 mm) is achieved.

SU authors certificate No 1357402 describes a “Method of treating of porous building materials”, wherein porous building elements of a foam concrete are subjected to retorting and to a preliminary vacuum treatment at up to 95-99.5% of vacuum for 10-25 min. The method comprises impregnating the material with an aqueous emulsion of silicone rubber compositions, subjecting the material to an additional vacuum treatment at the former level of vacuum for half the time of preliminary vacuum treatment. The average depth of impregnation according to this method is 15 mm (plus/minus 1.5-2 mm).

Above method has several disadvantages, including:

the process is expensive as preliminary drying and heating of the material at up to 60° C., the second vacuum treatment and an additional step of dyeing the material is required;

the depth of the impregnated layer of the material is insufficient due to hydraulic shock and damaged capillary structure of the material, caused by the fast removal of the material from the vacuum. Damaged capillary structure renders it difficult for the impregnating composition to infiltrate into the material, resulting in reduced mechanical endurance and lessened quality of the material.

Desirable in the art of are additional, simplified and economical methods of processing porous materials to improve the weather resistance and finish of such materials.

### SUMMARY

In view of the foregoing, the following provides a method for processing porous building materials.

In one embodiment, a method of processing porous building materials in an impregnation chamber, the method comprises:

creating a vacuum in the impregnation chamber and subjecting the materials to the vacuum for a first predetermined time;

impregnating the materials by spraying a mixture, comprising a dye and a hydrophobic impregnant, into the impregnation chamber at first predetermined pressure (from about 6 atm to about 30 atm), thereby creating misty environment of the mixture, and subjecting the materials to the mixture for 0.5-10 minutes, while gradually increasing the pressure (i.e., reducing the vacuum) in the impregnation chamber until the second predetermined pressure, preferably the atmospheric pressure is achieved in the impregnation chamber.

The step of impregating the products are carried out one to ten times, depending on the material and its porosity.

In one embodiment, latex or acryl based dye with diffusion qualities is used in the mixture. Silicon-based impregnants with film forming qualities are used as the hydrophobic impregnant.

Porous building materials, such as bricks, cement or gypsum based products, ceramics products, natural stone (marble, granite, limestone), wood and timber based products, can be processed according to disclosed methods.

Spraying the mixture of the dye and the hydrophobic impregnant to the impregnation chamber combines the operations of dyeing and impregnating the material, resulting in simpler and cheaper manufacturing process.

Spraying the mixture into the impregnation chamber at about 6 to about 30 atm disperses the mixture to a gas-like, misty environment, ensuring that the mixture is deeply penetrated into the pores of the material.

Spraying the mixture at less than 6 atm is usually not sufficient as the velocity of the dispersed particles of the mixture is too low to penetrate deeply enough into the pores of the material (i.e., thickness of the treated layer is not sufficient) and the material will not be sufficiently weatherproof. Spraying the mixture at more than 30 atm is usually economically and technologically impractical as makes the process more expensive without improving the quality of the treated material.

Spraying the mixture to the impregnation chamber for 0.5-10 minutes ensures smooth lowering of the vacuum (i.e., increasing the pressure) in the chamber, thereby avoiding hydraulic shock, which results in preserving the integrity of the porous structure of the material and thus, results in formation of a dyed and hydrophobic layer with a required thickness on the building material.

Decreasing the spraying time to less than 0.5 minutes results in decreased thickness of the treatable layer, and may also result in hydraulic shock, damaging the capillary structure of the material, further decreasing the depth of penetration of the mixture into the material. As a result, the material will have insufficient mechanical endurance and quality.

Impregnating can be carried out one to ten times, depending on the capillary and porous structure of the material. The number of pores (porosity) in a solid object and their size serve as basis for dividing solid objects into subcapillary (below 0.2 mc), capillary (0.2-100 mc) and supercapillary (above 100 mc). Building materials generally have porous structures with different porosity; the number of required impregnations is inversely proportional to their structure.

Materials with supercapillary structure such as bricks, light concrete, and timber based products are impregnated once. Materials with capillary structure such as cement based materials (chip-cement boards, fibre cement boards, asbestos-cement boards) are impregnated two to five times. Materials with subcapillary structure such as some types of ceramics and natural stone, are impregnated five to ten times.

Using dyes with diffusion qualities in the presence of forwarding pressure and vacuum allows increasing the velocity of the particles of the mixture in the chamber and the depth of penetration into the building material.

Using latex or acryl based dyes provides a surface with high resistance to water, abrasion, UV light, and salting out. Such dyes have high coverage, good filling; and it does not turn yellow over time.

Using hydrophobic impregnants with film forming qualities protects buildings and constructions from humidity and cold. Silicone based impregnant controls steam-to-water diffusion, i.e. allowing the surface to “breathe”, giving out the excessive humidity, and blocking the unnecessary humidity from getting into the material.

Bricks, cement based products, ceramics products, gypsum based products, natural stone, such as marble, granit and limestone, wood and timber based products can processed, providing weatherproof, highly hydrophobic and cold resistant materials; in addition, impregnating these materials with a mixture comprising dye provides material with improved finishes of various colors.

In the case of a wood or timber based material, the processed material also possesses reduced linear expansion rate in a humid environment.

The construction and method of operation of the invention, however, together with additional objects and advantages thereof will be best understood from the following description of specific embodiments.

### DESCRIPTION

The following will provide a detailed description of a method of processing porous building materials in an impregnation chamber, the method comprising:

creating vacuum in the impregnation chamber and subjecting the materials to the vacuum for a first predetermined time;

impregnating the material by spraying a mixture, comprising a dye and a hydrophobic impregnant, to the impregnation chamber at predetermined pressure (from about 6 atm to about 30 atm), thereby creating misty environment of the mixture, and subjecting the materials to the mixture for 0.5-10 minutes, while gradually increasing the pressure (i.e., reducing the vacuum) in the impregnation chamber until atmospheric pressure is achieved.

The following examples describe the modes for carrying out the method.

### EXAMPLE 1

Sand-lime bricks were laid on scaffolding ensuring access to any surface of the bricks, and were placed, without preliminary drying or heating, into the impregnation chamber of autoclave type. A traditional vacuum pump was used to remove 99.9% of the air from the chamber and the bricks were kept in the chamber for 10 minutes (first predetermined time). As a result, the air was totally exhausted from the pores of the bricks. Then, using a spray nozzle, located in the chamber, the mixture of a acryl based dye and a hydrophobic liquid was sprayed continuously into the chamber at 12 atm until atmospheric pressure was reached in the chamber (total balancing of vacuum).

The mixture was prepared by mixing dye Fassaden Fullfarbe (manufacturer MIPA AG, Germany) with hydrophobic liquid WBS Mikrosil (also MIPA AG, Germany) with a ratio of 1:1. The amount of the dye and the hydrophobic liquid can be altered to achieve required operational characteristics (hue, hydrophobia) of the building material.

Spraying the mixture through a spray nozzle at 12 atm disperses the mixture to a gas-like condition, creating a misty environment and ensuring that the mixture is deeply penetrated into the pores of the bricks. At the same time, the vacuum in the chamber decreases (i.e., the pressure increases), being inversely proportional to the amount of the sprayed mixture.

The mixture was sprayed for 2 minutes, wherein the pressure at the end of the process was equal to the atmospheric pressure. Smooth reducing of vacuum provides that the mixture fills each pore and that the structure of the bricks is not damaged (which would be a result of hydraulic shock when liquid impregnants are used and when the pressure is changed from vacuum to atmospheric momentarily). The structure of the sand-lime brick is supercapillary, so it was sufficient to carry out the impregnating only once.

For building materials with capillary structures, the impregnating must be carried out 2 to 3 times to achieve required characteristics of the materials. For building materials with subcapillary structures, the impregnating must be carried out 3 to 10 times.

### EXAMPLE 2

As an example of treating cement based products, a chip-cement board of type TSP-1 (1250 by 2600 by 10 cm, commercially available from several manufacturers in Russia) was used. Steps as in example 1 where performed, wherein the mixture was sprayed into the chamber at 12 atm for 1.5 minutes. The same dye and hydrophobic liquid was used at the same ratio for preparing the mixture. Impregnating was carried out twice.

### EXAMPLE 3

Ceramic bricks of type 100 (manufactured in Russia) were used. Steps as in previous examples were performed, wherein the mixture was sprayed into the chamber at 8 atm for 0.5 minutes. The same dye and hydrophobic liquid was used at the same ratio to prepare the mixture. Impregnating was carried out once.

### EXAMPLE 4

An unpolished marble plate of 300×300×10 cm was used. Transparent dye for manufacturing colored glass was used in the mixture. The mixture was sprayed into the chamber at 16 atm for 5 min. The impregnating was carried out five times. The depth of dyeing/impregnation was through the material. The structure of the marble did not change and became hydrophobic. No sugar effect was observed and the natural pattern of the stone was preserved. It is possible to give the marble any color, tone and tint.

### EXAMPLE 5

Karelian granite plate (300 by 300 by 10 cm, manufactured by Diabaz Ltd, Karelia, Russia) was treated as described above. Transparent colors were used to prepare the mixture. The mixture was administered at 30 atm for 10 minutes and the impregnating was carried out ten times. As in the case of marble, natural pattern of the product, including its color tone and natural impurities, was preserved while substantially increasing water resistance of the material.

### EXAMPLE 6

As an example of gypsum based products, a fibre gypsum board with timber based fibres (cellulose) (manufactured by GVL, Denmark) 1200 by 2500 by 13 mm was used. The mixture was sprayed at 8 atm for 1 minute. The impregnating was carried out once. The depth of the treating was through the board.

The testing of the method of treating porous building materials applied were carried through in the laboratory of OOO “Extrom”, City of Vladimir, Russia.

Although this invention is described with respect to a set of aspects and embodiments, modifications thereto will be apparent to those skilled in the art. The foregoing description of the embodiments of the invention has been presented for the purposes of illustration and description. It is not intended to be exhaustive or to limit the invention to the precise form disclosed. Many modifications and variations are possible in light of this disclosure. It is intended that the scope of the invention be limited not by this detailed description, but rather by the claims appended hereto.

What is claimed is:

1. A method of processing porous building materials in an impregnation chamber, the method comprises:
creating vacuum in the impregnation chamber and subjecting the materials to the vacuum for a first predetermined time;
impregnating the materials by spraying a mixture, comprising a dye and a hydrophobic impregnant, into the impregnation chamber under a predetermined pressure, thereby creating a gas-like misty environment of the mixture, and subjecting the materials to the gas-like misty environment for a second predetermined time while gradually reducing the vacuum in the impregnation chamber until a second predetermined pressure is reached in the impregnation chamber.

2. As in claim 1, wherein the second predetermined pressure is the atmospheric pressure.

3. As in claim 2, wherein the first predetermined pressure is from approximately about 6 to approximately about 30 atm.

4. As in claim 3, wherein the second predetermined time is from approximately about 0.5 to approximately about 10 minutes.

5. As in claim 4, wherein the impregnating of the material is carried out from one to ten times.

6. As in claim 5, wherein the dye is latex or acryl based dye having diffusion qualities.

7. As in claim 6, wherein the hydrophobic impregnant is a silicone based liquid, having film-forming qualities.

8. As in claim 7, wherein bricks are used as the materials, the first predetermined time is approximately about 10 minutes, the first predetermined pressure is approximately about 12 atm, and the second predetermined time is approximately about 2 minutes.

9. As in claim 8, wherein the impregnating is carried out once.

10. As in claim 7, wherein cement based products are used as the materials, the first predetermined pressure is approximately about 12 atm, and the second predetermined time is approximately about 1.5 minutes.

11. As in claim 10, wherein the impregnating is carried out two times.

12. As in claim 7, wherein ceramics-based products are used as the materials, the first predetermined pressure is approximately about 8 atm, and the second predetermined time is approximately about 0.5 minutes.

13. As in claim 12, wherein the impregnating is carried out once.

14. As in claim 5, wherein marble plates are used as the materials, a transparent dye is used as the dye, the first predetermined pressure is approximately about 16 atm, the second predetermined time is approximately about 5 minutes.

15. As in claim 14, wherein the impregnating is carried out five times.

16. As in claim 5, wherein granite plates are used as the materials, a transparent dye is used as the dye, the first predetermined pressure is approximately about 30 atm, the second predetermined time is approximately about 10 minutes.

17. As in claim 7, wherein gypsum boards are used as the materials, the first predetermined pressure is approximately about 8 atm, the second predetermined time is about 1 minute and the impregnating is carried out once.

18. As in claim 7, wherein timber based products are used as the materials.

19. A method of processing a porous building material in an impregnation chamber, the method comprises:
introducing the material into the impregnation chamber;
creating vacuum in the impregnation chamber and subjecting the material to the vacuum;
impregnating the material by spraying a mixture, comprising a dye and a hydrophobic impregnant, into the impregnation chamber under at approximately about 6 atm to 30 atm, thereby creating a gas-like misty environment of the mixture, and subjecting the material to the gas-like misty environment for 0.5 to 10 minutes while gradually reducing the vacuum in the impregnation chamber until the atmospheric pressure is reached in the impregnation chamber, wherein the impregnating is carried out one to ten times;
removing the material from the impregnation chamber

20. As in claim 19, wherein the material is selected from a group, consisting of bricks, cement based products, ceramics, marble, limestone, granite, wood, timber based products, and gypsum based products.
